(19) United States
(12) Patent Application Publication
(10) Pub. No.: US 2026/0348409 A1
(43) Pub. Date: Nov. 5, 2026

(54) HYDRAULIC ACTUATOR BEARING ASSEMBLY

(71) Applicant: Moog Inc., East Aurora, NY (US)

(72) Inventors: Richard H. Berg, Hilton, NY (US); Kyle J. Abbott, Buffalo, NY (US)

(21) Appl. No.: 19/474,245

(22) PCT Filed: Apr. 10, 2024
(86) PCT No.: PCT/US2024/023781

§ 371 Date: Oct. 10, 2025

Related U.S. Application Data
(60) Provisional application No. 63/458,721, filed on Apr. 12, 2023.

(51) Int. Cl. F15B 15/14; F15B 15/28

(52) U.S. Cl. CPC F15B 15/1423; F15B 15/2815

(57) ABSTRACT

A hydraulic actuator assembly comprising a hydraulic cylinder orientated about a center axis and having first and second hydraulic ports, a piston disposed in the cylinder and separating first and second chambers of the cylinder, the first and second chambers in fluid communication with the first and second hydraulic ports, a bearing between the cylinder and the piston having an outer bearing surface and an inner bearing surface, one of the outer or inner bearing surfaces comprising a profiled bearing surface defined at least in part by a bearing profile radius, one of the cylinder or piston comprising a profiled seat surface defined at least in part by a seat profile radius, and the seat profile radius being at least 105 percent greater than the bearing profile radius or the bearing profile radius being at least 105 percent greater than the seat profile radius.

### TECHNICAL FIELD

The present disclosure is directed to jet engine actuators, and more particularly to jet engine hydraulic actuator assemblies.

### BACKGROUND

Jet engines, such as gas turbine engines, often contain actuators configured to actuate moving parts of the engine. Such parts may include control flaps, guide vanes, doors, and the like.

### BRIEF SUMMARY

With parenthetical reference to corresponding parts, portions or surfaces of the disclosed embodiment, merely for the purposes of illustration and not by way of limitation, a hydraulic actuator assembly (15) is provided comprising: a hydraulic cylinder (30) orientated about a center axis (31) and having a first hydraulic port (32) for hydraulic fluid, a second hydraulic port (33) for the hydraulic fluid, and an inner cylinder surface (36) orientated generally about the center axis and defining a cylinder bore (38); a piston (40) disposed in the cylinder bore of the hydraulic cylinder and separating a first chamber (42) of the hydraulic cylinder from a second chamber (43) of the hydraulic cylinder; the piston operatively configured for sliding linearly movement on the center axis relative to the hydraulic cylinder within a linear range of motion and having an outer piston surface (46) orientated generally about the center axis; the first chamber of the hydraulic cylinder in fluid communication with the first hydraulic port and the second chamber of the hydraulic cylinder in fluid communication with the second hydraulic port; a first bearing (60a, 60b, 160a, 160b) disposed radially between the inner cylinder surface of the hydraulic cylinder and the outer piston surface of the piston; the first bearing having an outer bearing surface (61a, 62b, 161a, 162b) orientated opposite to the inner cylinder surface and an inner bearing surface (62a, 61b, 162a, 161b) orientated opposite to the outer piston surface; one of the outer bearing surface or the inner bearing surface comprising a cylindrical uniform bearing surface (61a, 61b, 161a, 161b) orientated about the center axis and the other of the outer bearing surface or the inner bearing surface comprising a profiled bearing surface (62a, 62b, 162a, 162b) defined at least in part by a bearing profile radius (63a, 63b, 163a, 163b); one of the inner cylinder surface or the outer piston surface comprising a cylindrical uniform glide surface (36a, 46b) orientated about the center axis and the other of the inner cylinder surface or the outer piston surface comprising a profiled seat surface (52, 72, 152, 172) defined at least in part by a seat profile radius (53, 73, 153, 173); the cylindrical uniform bearing surface orientated radially opposite the cylindrical uniform glide surface; the profiled bearing surface orientated radially opposite the profiled seat surface; and the seat profile radius (53, 73) being at least 105 percent greater than the bearing profile radius (63a, 63b) or the bearing profile radius (163a, 163b) being at least 105 percent greater than the seat profile radius (153, 173); whereby the profiled bearing surface is operatively configured to rotate relative to the profiled seat surface to maintain uniform contact between the cylindrical uniform bearing surface and the cylindrical uniform glide surface.

The seat profile radius (53, 73) may be at least 105 percent greater than the bearing profile radius (63a, 63b). The bearing profile radius (163 a, 163 b) may be at least 105 percent greater than the seat profile radius (153, 173).

The cylinder may comprise an end wall (35); the piston may comprise a piston head (44) and a piston rod (45); the piston rod may have a portion sealingly penetrating the end wall of the hydraulic cylinder. An outer piston surface (46b) of the piston rod (45) may comprise the uniform glide surface; an inner cylinder surface (70, 170) of the end wall may comprise the profiled seat surface defined at least in part by the seat profile radius (73, 173); the inner bearing surface (61b, 161b) may comprises the uniform bearing surface; and the outer bearing surface (62b, 162b) may comprise the profiled bearing surface defined at least in part by the bearing profile radius (63b, 163b). An outer piston surface (52, 152) of the piston head (44) may comprise the profiled seat surface defined at least in part by the seat profile radius (53, 153); the inner cylinder surface (36a) may comprise the uniform glide surface; the inner bearing surface (62a, 162a) may comprise the profiled bearing surface defined at least in part by the bearing profile radius (63a, 163a); and the outer bearing surface (61a, 161a) may comprise the uniform bearing surface. The hydraulic actuator assembly may comprise: a second bearing (60b, 160b) disposed radially between the inner cylinder surface of the hydraulic cylinder and the outer piston surface of the piston; the second bearing having a second outer bearing surface (62b, 162b) orientated opposite to the inner cylinder surface and a second inner bearing surface (61b, 161b) orientated opposite to the outer piston surface; the second inner bearing surface comprising a second cylindrical uniform bearing surface (61b, 161b) orientated about the center axis and the outer bearing surface comprising a second profiled bearing surface (62b, 162b) defined at least in part by a second bearing profile radius (63b, 163b); the outer piston surface comprising a second cylindrical uniform glide surface (46b) orientated about the center axis and the inner cylinder surface comprising a second profiled seat surface (62b, 162b) defined at least in part by a second seat profile radius (63b, 163b); an outer piston surface (46b) of the piston rod comprises the second uniform glide surface; an inner cylinder surface of the end wall (72, 172) comprises the second profiled seat surface defined at least in part by the second seat profile radius (73, 173); the second inner bearing surface (61b, 161b) comprises the uniform bearing surface; and the second outer bearing surface (62b, 162b) comprises the second profiled bearing surface defined at least in part by the second bearing profile radius (63b, 163b). The piston rod may be configured to actuate a first object (91) of an aircraft or a mobile machine. The hydraulic actuator assembly may comprise a linkage (90) between the piston rod and the first object.

The hydraulic actuator assembly may comprise a position sensor (24) configured to sense position of the piston. The hydraulic actuator assembly may comprise a tubular sleeve forming at least in part the inner cylinder surface. The hydraulic actuator assembly may comprise a hydraulic pump (22) connected with the first hydraulic port of the hydraulic cylinder and the second hydraulic port of the hydraulic cylinder, and a motor (21) operatively configured to drive the hydraulic pump. The hydraulic actuator assembly may comprise a valve (23) connected with the hydraulic pump, the first hydraulic port of the hydraulic cylinder, and the second hydraulic port of the hydraulic cylinder. The valve may comprise an electrohydraulic servovalve. The hydraulic actuator assembly may comprise a controller (25) that receives input signals and outputs command signals. The bearing may comprise a hard material.

### BRIEF DESCRIPTION OF THE DRAWINGS

The accompanying drawings are incorporated herein as part of the specification. The drawings described herein illustrate embodiments of the presently disclosed subject matter and are illustrative of selected principles and teachings of the present disclosure. However, the drawings do not illustrate all possible implementations of the presently disclosed subject matter and are not intended to limit the scope of the present disclosure in any way.

FIG. 1 is perspective schematic view of an embodiment of the improved hydraulic actuator assembly mounted in a jet engine of an aircraft.

FIG. 2 is a longitudinal cross-sectional view of a first embodiment of the hydraulic cylinder and piston assembly shown in FIG. 1.

FIG. 3 is an enlarged view of the cylinder and piston interface shown in FIG. 2.

FIG. 4 is an enlarged view of the cylinder piston head bearing assembly shown in FIG. 3.

FIG. 5 is an enlarged view of the cylinder piston rod bearing assembly shown in FIG. 3.

FIG. 6 is a longitudinal cross-sectional view of a second embodiment of the hydraulic cylinder and piston assembly shown in FIG. 1.

FIG. 7 is an enlarged view of the cylinder and piston interface shown in FIG. 6.

FIG. 8 is an enlarged view of the cylinder piston head bearing assembly shown in FIG. 7.

FIG. 9 is an enlarged view of the cylinder piston rod bearing assembly shown in FIG. 7.

FIG. 10 is an exploded perspective view of the piston rod bearing shown in FIG. 5.

FIG. 11 is a perspective view of the piston rod bearing shown in FIG. 7.

### DETAILED DESCRIPTION OF THE EMBODIMENTS

At the outset, it should be clearly understood that like reference numerals are intended to identify the same structural elements, portions, or surfaces consistently throughout the several drawing figures, as such elements, portions or surfaces may be further described or explained by the entire written specification, of which this detailed description is an integral part. Unless otherwise indicated, the drawings are intended to be read (e.g., crosshatching, arrangement of parts, proportion, degree, etc.) together with the specification, and are to be considered a portion of the entire written description of this invention. As used in the following description, the terms “horizontal”, “vertical”, “left”, “right”, “up” and “down”, as well as adjectival and adverbial derivatives thereof (e.g., “horizontally”, “rightwardly”, “upwardly”, etc.), simply refer to the orientation of the illustrated structure as the particular drawing figure faces the reader. Similarly, the terms “inwardly” and “outwardly” generally refer to the orientation of a surface relative to its axis of elongation, or axis of rotation, as appropriate.

It is to be understood that the specific assemblies and systems illustrated in the attached drawings and described in the following specification are simply exemplary embodiments of the inventive concepts defined herein. Hence, specific dimensions, directions, or other physical characteristics relating to the embodiments disclosed are not to be considered as limiting, unless expressly stated otherwise. Also, although they may not be, like elements in various embodiments described herein may be commonly referred to with like reference numerals within this section of the application. It is to be appreciated that the present teaching is by way of example only, not by limitation. Where they are used herein, the terms “first,” “second,” and so on, do not necessarily denote any ordinal, sequential, or priority relation, but are simply used to distinguish one element or set of elements more clearly from another, unless specified otherwise.

The term “shaft” or “rod” includes, but is not limited to, cylindrical shafts or rods, shafts or rods of polygonal cross-section and shafts or rods without a uniform cross-section. It is further noted that a shaft or rods does not need to be cylindrical in order to define a radial direction or a lengthwise direction.

To the extent that the definitions provided above are consistent with ordinary, plain, and accustomed meanings (as generally evidenced, in alia, by dictionaries and/or technical lexicons), the above definitions shall be considered supplemental in nature. To the extent that the definitions provided above are inconsistent with ordinary, plain, and accustomed meanings (as generally evidenced, inter alia, by dictionaries and/or technical lexicons), the above definitions shall control. If the definitions provided above are broader than the ordinary, plain, and accustomed meanings in some aspect, than the above definitions will control at least in relation to their broadening aspects.

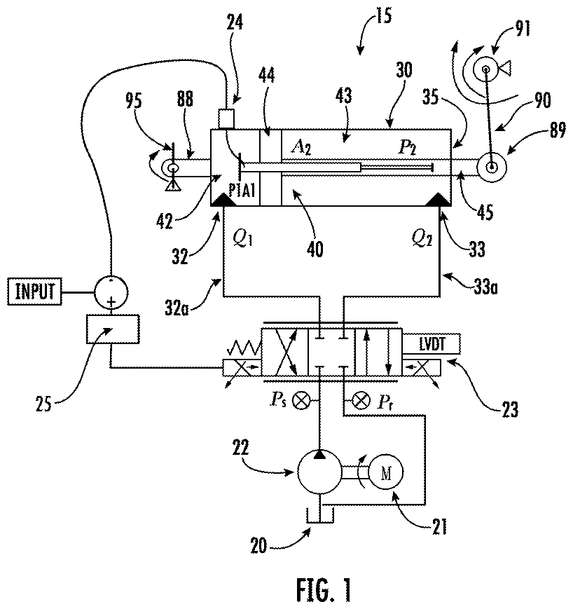

Referring now to the drawings, an improved hydraulic actuator assembly is provided, an embodiment of which is generally indicated at 15. As shown in FIG. 1, hydraulic actuator assembly 15 is a hydraulic cylinder piston assembly and is operatively configured to hydraulically connect to tank 20 of an aircraft via hydraulic pump 22 driven by motor 21 and electrohydraulic servovalve 23. Thus, in this embodiment pump 22 pressurizes aircraft fuel from fuel tank 20 to raise the pressure in a hydraulic gap on one side or the other of piston head 44 of hydraulic piston 40 of assembly 15.

Motor 21 may be a variable speed single or bidirectional electric servomotor and pump 22 may be a single or bidirectional pump driven by motor 21. In this embodiment, motor 21 is a brushless D. C. variable-speed servo-motor that is supplied with a current. Motor 21 has an inner rotor with permanent magnets and a fixed non-rotating stator with coil windings. When current is appropriately applied through the coils of the stator, a magnetic field is induced. The magnetic field interaction between the stator and rotor generates torque which may rotate an output shaft connected to pump 22. Other motors may be used as alternatives. For example, a variable speed stepper motor, brush motor or induction motor may be used.

Pump 22 may be a fixed displacement single directional gear pump or a bidirectional internal two-port gear pump. The pumping elements, namely gears, are capable of rotating in one or both directions and allows for fluid to be added into and out of the system as the system controller closes the control loop of position or pressure. The shaft of at least one gear of pump 22 is connected to the output shaft of motor 21 with the other pump gear following. Other pumps may be used as alternatives. For example, a variable displacement pump may be used. Also, in an alternative embodiment, pump 22 is driven by a gear box connected to the turbine shaft of the engine of the aircraft. In this embodiment, the shaft of at least one gear of pump 22 is connected to the output shaft of the gear box with the other pump gear following.

Servovalve 23 is an electrohydraulic servovalve that controls the pressurized fluid from pump 22 that is sent to actuator 15 and the hydraulic pressure differential on piston head 44 of piston 40 of assembly 15. In this embodiment, servovalve 23 is a single stage servovalve having a torque motor that positions a spool valve in response to an input signal. Servovalve 23 receives pressurized hydraulic fluid from pump 22 and transfers the fluid to the ports 32 and 33 of hydraulic cylinder 30 in a controlled manner and based on feedback from position sensor 24.

In this embodiment, hydraulic piston assembly 15 includes piston 40 slidably disposed within cylindrical housing 30 such that piston 40 may be driven in both directions relative to housing 30. Piston 40 includes piston head 44 and piston rod 45 extending through cylinder end wall 35 from piston head 44. Piston head 44 is slidably disposed within cylinder 30, and sealingly separates left chamber 42 from right chamber 43. In this embodiment, the leftwardly-facing annular vertical end surface of piston head 44 faces into left chamber 42 and the rightwardly-facing annular vertical end surface of piston head 44 faces into right chamber 43. Left chamber 42 has fluid port 32 and right chamber 43 has fluid port 33. Position sensor 24 is configured to sense the position of piston 40 in cylinder 30. As shown servovalve 23 communicates with left chamber 42 via cylinder port 32 and fluid line 32a and communicates with right chamber 43 via cylinder port 33 and fluid line 33a, respectively. Rod 45 is mounted to piston head 44 for movement with piston head 44 and extends to the right and sealingly penetrates right end wall 35 of cylinder 30. Motor 21 turns pump 22 and pump 22 is hydraulically connected to piston 40 via servovalve 23. Tank 20, pump 22, servovalve 23 and hydraulic cylinder assembly 15 provide a hydrostatic transmission, so as pump 22 spins and valve 23 is actuated to a first position, piston 40, including piston head 44 and rod 45, move in a first direction and as pump 22 spins and valve 23 is actuated to a second position, piston 40 moves in the other direction. Thus, piston 40 will extend or move rod 45 to the right when valve 23 is in a first position and motor 21 rotates pump 22 to move fuel from fuel tank 20 into chamber 42 through port 32. Piston 40 will retract rod 45 or move to the left when valve 23 is in a second position and motor 21 rotates pump 22 to move fuel into chamber 43 through port 33.

The position of rod 45 of piston 40 is monitored via position sensor 24 and the position signals are then fed back to controller 25. In this embodiment, position sensor 24 is a linear variable differential transformers (LVDT) having an electromechanical transducer that provides a variable alternating current output voltage that is generally linearly proportional to the linear displacement of piston rod 45. Servovalve 23, motor 21 and pump 22 control the speed and force of piston head 44 and thus rod 45 by changing the flow and differential pressure acting on piston head 44 in cylinder 30. This is accomplished by looking at the feedback of position sensor 24 and then closing the control loop by adjusting servovalve 23 and motor 21 accordingly. While in this embodiment position sensor 24 is a LVDT, other position sensor may be used such as without limitation encoders, hall position sensors, potentiometers, and resolvers.

As shown in FIG. 1, in this embodiment the left end of cylinder housing 30 is pivotally connected at pivot connection 88 to linkage 95, which is in turn connected to the structure of an aircraft. The outer right end of rod 45 of assembly 15 is pivotally connected at pivot connection 89 to linkage 90, which is in turn connected to an object 91 to be actuated relative to the structure of the aircraft. Thus, in this embodiment assembly 15 translates linearly to provide rotational motion. However, other types of connections and other types of linkages may be employed as alternatives.

As shown in FIGS. 1-3, 6 and 7, cylinder 30 is orientated about center axis 31 and has dual diameter inner cylinder surface 36 defining dual diameter cylinder bore 38 and end wall 35. The left wider portion 38a of bore 38 is defined by inner cylinder surface 36a of cylinder 30 orientated about center axis 31 and the right narrower portion 38b of bore 38 is defined by inner cylinder surface 36b of cylinder 30 orientated about center axis 31. Piston 40 is disposed in bore 38, with piston head 44 disposed in portion 38a and separating chamber 42 of the hydraulic cylinder from chamber 43 of the hydraulic cylinder, and piston rod 45 is disposed in portion 38b and extends to the right therefrom. Piston head 44 has outer piston head surface 46a orientated about center axis 31 facing inner cylinder surface 36a of cylinder 30 and piston rod 45 has outer piston rod surface 46b orientated about center axis 31 facing inner cylinder surface 36b of cylinder 30. Thus, piston 40 is operatively configured for sliding linear movement on center axis 31 relative to cylinder 30 within a linear range of motion.

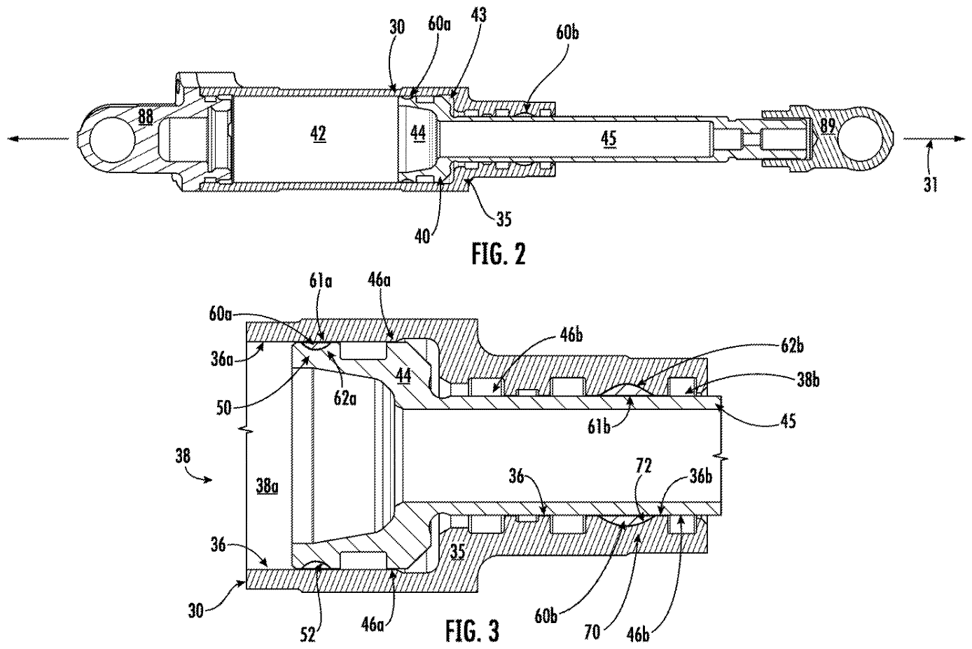

In a first embodiment shown in FIGS. 2-5 and 10, annular support bearing or wear ring 60a is disposed radially between inner cylinder surface 36a of cylinder 30 and outer piston surface 46a of piston head 44 of piston 40. Annular support bearing or wear ring 60b is disposed radially between inner cylinder surface 36b of cylinder 30 and outer piston surface 46b of piston rod 45 of piston 40. Bearing ring 60a thereby provides a bearing surface to inner surface 36a of cylinder 30 for piston head 44 of piston 40 and bearing ring 60b thereby provides a bearing surface to inner surface 36b of cylinder 30 for piston rod 45 of piston 40.

Bearings 60a and 60b are formed of a hard material that is resistant to high temperatures. For example, and without limitation, bearings 60a and 60b may be formed of a carbon-graphite material, which is resistant to high radial loads and operating temperatures that can exceed 300 degrees Fahrenheit. In certain embodiments, bearings 60a and 60b are formed of a material having a Shore Scleroscope hardness of 80 or greater. Other materials may be used to achieve the desired hardness and temperature resistance, including without limitation metals and metal alloys, such as for example a nickel, aluminum bronze alloy.

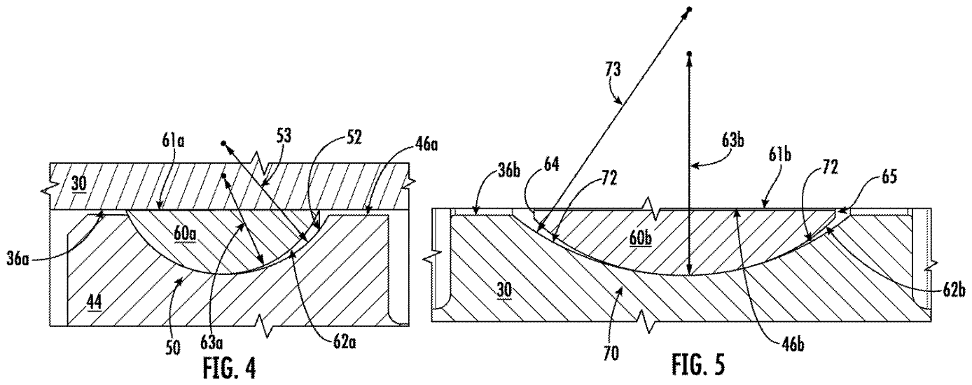

As shown in FIGS. 3 and 4, bearing 60a is a ring-like structure having a segmented longitudinal cross-sectional profile bounded by outwardly-facing chordal plano cylindrical surface 61a orientated about center axis 31 and inwardly-facing convex arcuate surface 62a defined by arc profile radius 63a. As shown, bearing 60a is disposed in annular piston groove or seat 50 in piston head 44 having outwardly-facing concave arcuate surface 52 defined by arc profile radius 53. Arc profile radius 53 of outer concave piston seat surface 52 is greater than arc profile radius 63a of inner convex bearing surface 62a. Arc profile radius 53 of outer concave piston seat surface 52 may be at least 105 percent greater than arc profile radius 63a of inner convex bearing surface 62a, and in certain embodiments may be between 105 percent and 125 percent greater.

As shown, this configuration provides sufficient bearing edge clearance that bearing 60a can rotate or rock in piston radial groove 50 under loading and outer cylindrical surface 61a of bearing 60a can thereby maintain more uniform area contact with opposed inner cylindrical surface 36a of cylinder 30 as outer cylindrical surface 61a of bearing 60a and opposed inner cylindrical surface 36a of cylinder 30 remain parallel. The outer circumferential surface 46a of piston head 44 also has sufficient clearance that bearing 60a can gimbal angularly to enable fuller surface-to-surface contact without an edge rolling into contact. This configuration provides significantly higher contact area between contact surfaces 61a and 36a under high loads and temperatures, which results in greater and improved distribution of the load and reduction in the wear rate of the assembly.

As shown in FIGS. 3, 5 and 10, bearing 60b is a ring-like structure having a generally segmented longitudinal cross-sectional profile bounded by inwardly-facing chordal plano cylindrical surface 61b orientated about center axis 31, leftwardly-facing annular surface 64, outwardly-facing convex arcuate surface 62b defined by arc profile radius 63b, and rightwardly-facing annular surface 65. As shown, bearing 60b is disposed in annular cylinder groove or seat 70 in cylinder 30 having inwardly-facing concave arcuate surface 72 defined by arc profile radius 73. Arc profile radius 73 of inner concave piston seat surface 52 is greater than arc profile radius 63b of outer convex bearing surface 62b. Arc profile radius 73 of inner concave piston seat surface 72 may be at least 105 percent greater than arc profile radius 63b of outer convex bearing surface 62b, and in certain embodiments may be between 105 percent and 125 percent greater.

As shown, this configuration provides sufficient bearing edge clearance that bearing 60b can rotate or rock in cylinder radial groove 70 under loading and inner cylindrical surface 61b of bearing 60b can thereby maintain more uniform area contact with opposed outer cylindrical surface 46b of piston rod 45 of piston 40. The outer circumferential surface 36b of cylinder 30 also has sufficient clearance that bearing 60b can gimbal angularly to enable fuller surface-to-surface contact without an edge rolling into contact. This configuration provides significantly higher contact area between contact surfaces 61b and 46b under high loads and temperatures, which results in greater and improved distribution of the load and reduction in the wear rate of the assembly. Thus, the assembly provides fuller surface to surface contact with self-alignment at the sliding surfaces of the bearing while the mating surfaces can rotate, rock or pivot as the piston deflects in angular displacement or to account for any assembly clearances.

Accordingly, to enable such pivot with sufficient contact area, an arc mismatch ratio is provided in which the bearing arc is proportionally smaller than the mated receiving groove arc. In addition, the bearing has sufficient clearance at each outer edge of the bearing to the mated receiving groove, which prevents the bearing's outer edge from rolling into contact with the mated receiving groove arc.

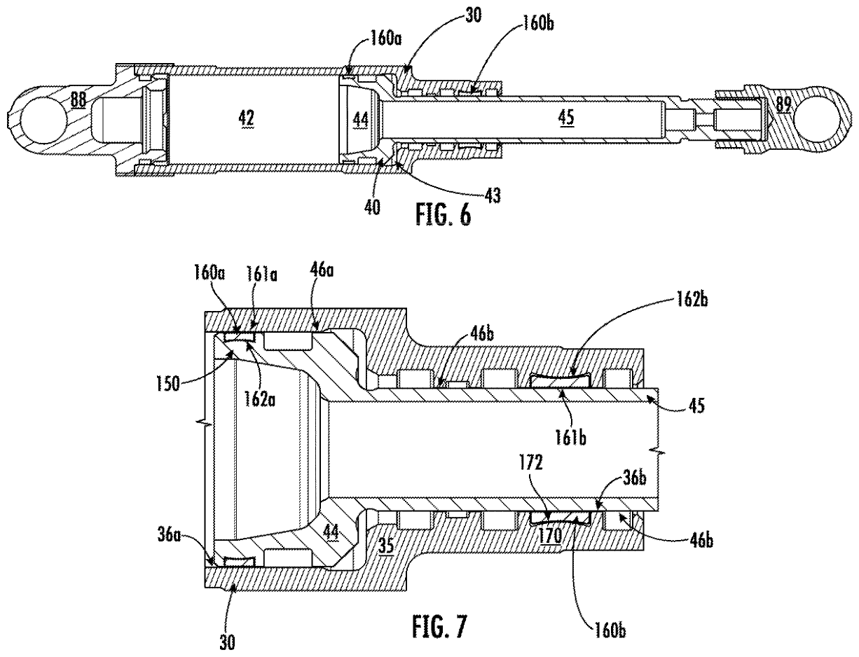

A second inverted support bearing embodiment is shown in FIGS. 6-9 and 11. As shown, cylinder 30 and piston 40 are structurally the same as the first embodiment. However, the piston bearing groove, cylinder bearing groove and bearings in this embodiment are inverted relative to the first embodiment.

As shown, annular support bearing or wear ring 160a is disposed radially between inner cylinder surface 36a of cylinder 30 and outer piston surface 46a of piston head 44 of piston 40. Annular support bearing or wear ring 160b is disposed radially between inner cylinder surface 36b of cylinder 30 and outer piston surface 46b of piston rod 45 of piston 40. Bearing ring 160a thereby provides a bearing surface to inner surface 36a of cylinder 30 for piston head 44 of piston 40 and bearing ring 160b thereby provides a bearing surface to inner surface 36b of cylinder 30 for piston rod 45 of piston 40.

Bearings 160a and 160b are formed of a hard material that is resistant to high temperatures. For example, and without limitation, bearings 160a and 160b may be formed of a carbon-graphite material, which is resistant to high radial loads and operating temperatures that can exceed 300 degrees Fahrenheit. In certain embodiments, bearings 160a and 160b are formed of a material having a Shore Scleroscope hardness of 80 or greater. Alternative metal and alloy materials may be used as well.

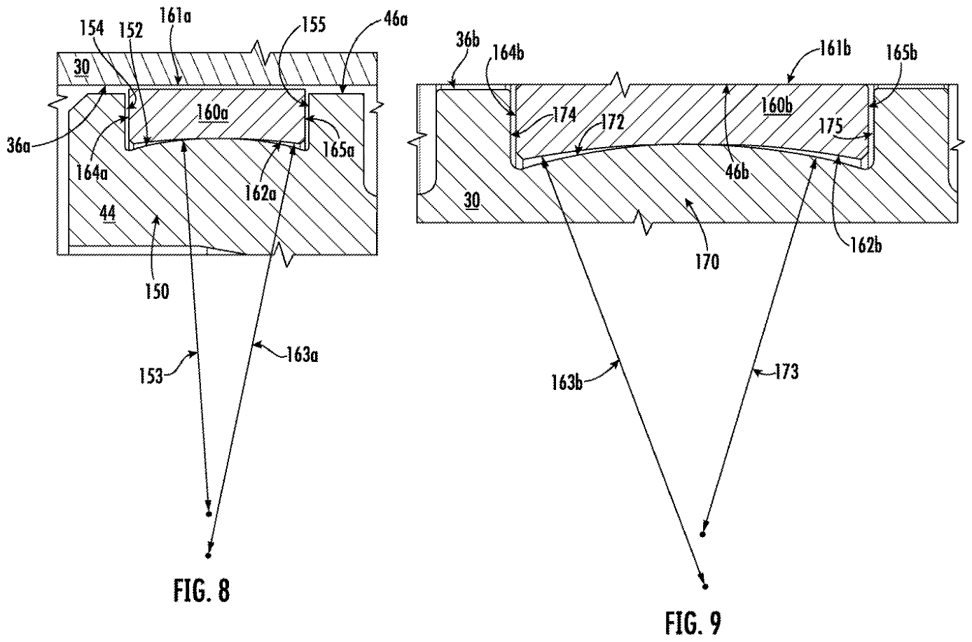

As shown in FIGS. 7 and 8, bearing 160a is a ring-like structure having a longitudinal cross-sectional profile bounded by outwardly-facing chordal plano cylindrical surface 161a orientated about center axis 31, rightwardly-facing annular surface 165a, inwardly-facing concave arcuate surface 162a defined by arc profile radius 163a, and leftwardly-facing annular surface 164a. As shown, bearing 160a is disposed in annular piston groove or seat 150 in piston head 44 defined by rightwardly-facing annular surface 154, outwardly-facing convex arcuate surface 152 defined by arc profile radius 153, and leftwardly-facing annular surface 155. Arc profile radius 153 of outer convex piston seat surface 152 is less than arc profile radius 163a of inner concave bearing surface 162a. Arc profile radius 163a of inner concave bearing surface 162a may be at least 105 percent greater than arc profile radius 153 of outer convex piston seat surface 152, and in certain embodiments may be between 105 percent and 125 percent greater.

As shown, this configuration provides sufficient bearing edge clearance that bearing 160a can rotate or rock in piston radial groove 150 under loading and outer cylindrical surface 161a of bearing 160a can thereby maintain more uniform area contact with opposed inner cylindrical surface 36a of cylinder 30. The outer circumferential surface 46a of piston head 44 has sufficient clearance that bearing 160a can gimbal angularly to enable fuller surface-to-surface contact without an edge rolling into contact. This configuration provides significantly higher contact area between contact surfaces 161a and 36a under high loads and temperatures, which results in greater and improved distribution of the load and reduction in the wear rate of the assembly.

As shown in FIGS. 7, 9 and 11, bearing 160b is a ring-like structure having a longitudinal cross-sectional profile bounded by inwardly-facing chordal plano cylindrical surface 161b orientated about center axis 31, leftwardly-facing annular surface 164b, outwardly-facing concave arcuate surface 162b defined by arc profile radius 163b, and rightwardly-facing annular surface 165b. As shown, bearing 160b is disposed in annular cylinder groove or seat 170 in cylinder 30 defined by rightwardly-facing annular surface 174, outwardly-facing convex arcuate surface 172 defined by arc profile radius 173, and leftwardly-facing annular surface 175. Arc profile radius 173 of outer convex piston seat surface 172 is less than arc profile radius 163b of inner concave bearing surface 162b. Arc profile radius 163 b of inner concave bearing surface 162 b may be at least 105 percent greater than arc profile radius 173 of outer convex piston seat surface 172, and in certain embodiments may be between 105 percent and 125 percent greater.

As shown, this configuration provides sufficient bearing edge clearance that bearing 160b can rotate or rock in cylinder radial groove 170 under loading and inner cylindrical surface 161b of bearing 160b can thereby maintain more uniform area contact with opposed outer cylindrical surface 46b of piston rod 45 of piston 40. The outer circumferential surface 36b of cylinder 30 also has sufficient clearance that bearing 160b can gimbal angularly to enable fuller surface-to-surface contact without an edge rolling into contact. This configuration provides significantly higher contact area between contact surfaces 161b and 46b under high loads and temperatures, which results in greater and improved distribution of the load and reduction in the wear rate of the assembly. Thus, the assembly provides fuller surface to surface contact with self-alignment at the sliding surfaces of the bearing while the mating surfaces can rotate, rock or pivot as the piston deflects in angular displacement or to account for any assembly clearances.

One or more annular seals may be located in seal glands in piston head 40 axially next to bearing 60a or 160a between inner surface 36a of cylinder 30 and outer piston surface 46a of piston head 44. One or more annular seals may also be located in seal glands in cylinder 30 axially next to bearing 60b or 160b between inner surface 36b of cylinder 30 and outer piston surface 46b of piston rod 45.

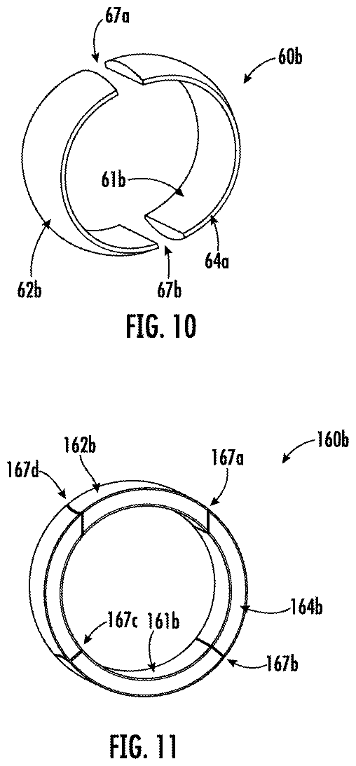

Since graphite-based bearings 60a, 60b, 160a and 160b are rigid elements, they are split by precision fracture or cut via EDM so as to minimize any assembly gaps between the two or more segments that make up the entire circumference of the bearing. Thus, as shown in FIG. 10, bearing 60b may be split into two halves via two radial slits 67a and 67b so they can be positioned in cylinder groove 70 during assembly. Similarly, as shown in FIG. 11, bearing 160b may be split into four segments via four specially configured radial slits 67a, 67b, 67c and 67d so as to be positioned in cylinder groove 170 during assembly. This segmented bearing design for assembly may be used for seating the bearings in both external grooves and internal grooves as needed depending on the configuration.

The bearing radii being different than the opposed mating component groove radii, either greater or less depending on the bearing configuration as described above, enables the bearing to pivot, rock, rotate, or gimbal with any deflection of the piston or to account for any assembly clearances, which enables reaction loading to pass through the center face width of the bearing as the opposed bearing surfaces remain parallel. This shifts the load off the edge of the bearing and increases the wear life due to significant reduction in contact stress and enables a surface-to-surface contact and eliminates an edge to surface sliding contact. Also, sufficient clearance at the outer edge of the bearing from the opposed mating component surface avoids such edge contacting the surface given the magnitude of the reaction load. The arc ratio is scaled as function of the load and the bearing width.

It should be appreciated that certain features of the system, which are, for clarity, described in the context of separate embodiments, may also be provided in combination in a single embodiment. Conversely, various features, which are, for brevity, described in the context of a single embodiment, may also be provided separately or in any suitable combination. While various embodiments have been described in detail above, it should be understood that they have been presented by way of example, and not limitation. It will be apparent to persons skilled in the relevant arts that the disclosed subject matter may be embodied in other specific forms, variations, and modifications without departing from the scope, spirit, or essential characteristics thereof. The embodiments described above are therefore to be considered in all respects as illustrative, and not restrictive. The scope of the invention is indicated by the appended claims, and all changes that come within the meaning and range of equivalents thereof are intended to be embraced therein.

1. A hydraulic actuator assembly comprising:
a hydraulic cylinder orientated about a center axis and having a first hydraulic port for hydraulic fluid, a second hydraulic port for said hydraulic fluid, and an inner cylinder surface orientated generally about said center axis and defining a cylinder bore;
a piston disposed in said cylinder bore of said hydraulic cylinder and separating a first chamber of said hydraulic cylinder from a second chamber of said hydraulic cylinder;
said piston operatively configured for sliding linearly movement on said center axis relative to said hydraulic cylinder within a linear range of motion and having an outer piston surface orientated generally about said center axis;
said first chamber of said hydraulic cylinder in fluid communication with said first hydraulic port and said second chamber of said hydraulic cylinder in fluid communication with said second hydraulic port;
a first bearing disposed radially between said inner cylinder surface of said hydraulic cylinder and said outer piston surface of said piston;
said first bearing having an outer bearing surface orientated opposite to said inner cylinder surface and an inner bearing surface orientated opposite to said outer piston surface;
one of said outer bearing surface or said inner bearing surface comprising a cylindrical uniform bearing surface orientated about said center axis and the other of said outer bearing surface or said inner bearing surface comprising a profiled bearing surface having, in a longitudinal cross-section containing said center axis, an arcuate surface profile defined at least in part by a bearing profile radius;
one of said inner cylinder surface or said outer piston surface comprising a cylindrical uniform glide surface orientated about said center axis and the other of said inner cylinder surface or said outer piston surface comprising a profiled seat surface having, in a longitudinal cross-section containing said center axis, an arcuate surface profile defined at least in part by a seat profile radius;
said cylindrical uniform bearing surface orientated radially opposite said cylindrical uniform glide surface;
said profiled bearing surface orientated radially opposite said profiled seat surface; and
said seat profile radius being greater than said bearing profile radius or said bearing profile radius being greater than said seat profile radius such that said profiled bearing surface is operatively configured to rotate relative to said profiled seat surface to maintain uniform contact between said cylindrical uniform bearing surface and said cylindrical uniform glide surface.

2. The hydraulic actuator assembly set forth in claim 1, wherein said seat profile radius is at least 105 percent greater than said bearing profile radius.

3. The hydraulic actuator assembly set forth in claim 1, wherein said bearing profile radius is at least 105 percent greater than said seat profile radius.

4. The hydraulic actuator assembly set forth in claim 1, wherein:
said cylinder comprises an end wall;
said piston comprises a piston head and a piston rod; and
said piston rod has a portion sealingly penetrating said end wall of said hydraulic cylinder.

5. The hydraulic actuator assembly set forth in claim 4, wherein:
an outer piston surface of said piston rod comprises said cylindrical uniform glide surface;
an inner cylinder surface of said end wall comprises said profiled seat surface defined at least in part by said seat profile radius;
said inner bearing surface comprises said uniform bearing surface; and
said outer bearing surface comprises said profiled bearing surface defined at least in part by said bearing profile radius.

6. The hydraulic actuator assembly set forth in claim 4, wherein:
an outer piston surface of said piston head comprises said profiled seat surface defined at least in part by said seat profile radius;
said inner cylinder surface comprises said cylindrical uniform glide surface;
said inner bearing surface comprises said profiled bearing surface defined at least in part by said bearing profile radius; and
said outer bearing surface comprises said uniform bearing surface.

7. The hydraulic actuator assembly set forth in claim 6, comprising:
a second bearing disposed radially between said inner cylinder surface of said hydraulic cylinder and said outer piston surface of said piston;
said second bearing having a second outer bearing surface orientated opposite to said inner cylinder surface and a second inner bearing surface orientated opposite to said outer piston surface;
said second inner bearing surface comprising a second cylindrical uniform bearing surface orientated about said center axis and said outer bearing surface comprising a second profiled bearing surface having, in a longitudinal cross-section containing said center axis, an arcuate surface profile defined at least in part by a second bearing profile radius;
said outer piston surface comprising a second cylindrical uniform glide surface orientated about said center axis and said inner cylinder surface comprising a second profiled seat surface having, in a longitudinal cross-section containing said center axis, an arcuate surface profile defined at least in part by a second seat profile radius;
an outer piston surface of said piston rod comprises said second uniform glide surface;
an inner cylinder surface of said end wall comprises said second profiled seat surface defined at least in part by said second seat profile radius;
said second inner bearing surface comprises said uniform bearing surface;
said second outer bearing surface comprises said second profiled bearing surface defined at least in part by said second bearing profile radius; and
said second seat profile radius being greater than said second bearing profile radius or said second bearing profile radius being greater than said second seat profile radius.

8. The hydraulic actuator assembly set forth in claim 4, wherein said piston rod is configured to actuate a first object of an aircraft or a mobile machine.

9. The hydraulic actuator assembly set forth in claim 8, comprising a linkage between said piston rod and said first object.

10. The hydraulic actuator assembly set forth in claim 1, comprising a position sensor configured to sense position of said piston.

11. The hydraulic actuator assembly set forth in claim 1, wherein said cylinder comprises a tubular sleeve forming at least in part said inner cylinder surface.

12. The hydraulic actuator assembly set forth in claim 1, comprising a hydraulic pump connected with said first hydraulic port of said hydraulic cylinder and said second hydraulic port of said hydraulic cylinder, and a motor operatively configured to drive said hydraulic pump.

13. The hydraulic actuator assembly set forth in claim 12, comprising a valve connected with said hydraulic pump, said first hydraulic port of said hydraulic cylinder, and said second hydraulic port of said hydraulic cylinder.

14. The hydraulic actuator assembly set forth in claim 13, wherein said valve comprises an electrohydraulic servovalve.

15. The hydraulic actuator assembly set forth in claim 14, comprising a controller that receives input signals and outputs command signals.

16. The hydraulic actuator assembly set forth in claim 15, comprising a S configured to sense a position of said piston and to provide an input signal to said controller.

17. The hydraulic actuator assembly set forth in claim 1, wherein said first bearing comprises a material having a Shore Scleroscope hardness of at least 80.
